(19) United States
(12) Patent Application Publication
(10) Pub. No.: US 2025/0083563 A1
(43) Pub. Date: Mar. 13, 2025

(54) CHARGING HEALTH MONITORING DEVICE AND METHOD

(71) Applicant: TE Connectivity Solutions GmbH, Schaffhausen (CH)

(72) Inventors: Ram Kishore Venkatesan, Winston Salem, NC (US); David Bruce Sarraf, Elizabethtown, PA (US); Clara Marguerite Rhodes, Winston Salem, NC (US); Nathan Philip Myer, Lancaster, PA (US); Marjorie Kay Myers, Mount Wolf, PA (US); Aaron James de Chazal, Rochester, MI (US); Paul T. Angell, Winston Salem, NC (US); William A. Russell, JR., Winston Salem, NC (US); Skyler Krathwohl, Winston Salem, NC (US)

(21) Appl. No.: 18/462,556

(22) Filed: Sep. 7, 2023

(51) Int. Cl. B60L 58/16; B60L 53/16; B60L 53/62

(52) U.S. Cl. CPC B60L 58/16; B60L 53/16; B60L 53/62

(57) ABSTRACT

A charging health monitoring device for monitoring a health of a charging component for an electric vehicle includes a testing sensor held by a charging terminal and including a testing probe interfacing with a mating charging terminal. The charging health monitoring device includes a control circuit for controlling a charging operation and a testing operation. The control circuit measures a terminal voltage of the charging terminal and a sensor voltage of the testing sensor to determine resistance of the charging terminal and provide a test signal. The control circuit includes an electrically isolated switch receiving the test signal and generating a control signal based on the test signal for controlling a charging operation of the charging component. The control circuit performs the testing operation simultaneously with the charging operation.

### BACKGROUND OF THE INVENTION

The subject matter herein relates generally to charging systems for electric vehicles.

Current to recharge EV (Electric Vehicle) batteries can be supplied through a separable electrical interface consisting of a charging inlet on the vehicle and a charging plug that is connected to a charging station by a flexible cable. This separable electrical interface is subject to harsh operating conditions, including frequent cycling (mate-unmate), exposure to weather, and damage. These harsh operating conditions can reduce the serviceability, or electrical performance, of the connector by increasing the interface resistance. Moreover, since charging may occur at different locations the separable interface will occur between different components whose individual serviceability may also differ. Integrity of the charging interface is important for safe operation. Interfaces with high electrical resistance can result in excessive joule heating. Excess heating can lead to lower charging rates as an inlet temperature sensor becomes aware of the excess heating. It can also damage the charging inlet or charging plug if the charging station does not lower charging current quickly enough. The importance of a healthy (low electrical resistance) separable interface coupled with the potential for high variability in health between the various charging stations makes a method of monitoring or measuring interface health desirable.

### BRIEF DESCRIPTION OF THE INVENTION

In one embodiment, a charging health monitoring device for monitoring a health of a charging component for an electric vehicle is provided. The charging health monitoring device includes a charging terminal configured to be mated with a mating charging terminal to perform a charging operation for charging the electric vehicle. The charging health monitoring device includes a testing sensor held by the charging terminal. The testing sensor includes a testing probe. The testing probe is electrically isolated from the charging terminal. The testing probe includes a sensing interface configured to interface with a mating charging terminal. The charging health monitoring device includes a control circuit for the charging component. The control circuit is operably coupled to the charging terminal to control the charging operation using the charging terminal. The control circuit is operably coupled to the testing sensor to control a testing operation using the testing sensor. The control circuit measures a terminal voltage of the charging terminal. The control circuit measures a sensor voltage of the testing sensor. The control circuit determines resistance of the charging terminal and the mating charging terminal based on the measured terminal voltage and the measured sensor voltage. The control circuit provides a test signal based on the measured resistance. The control circuit includes an electrically isolated switch receiving the test signal. The electrically isolated switch generates a control signal based on the test signal. The control circuit is operably coupled to the charging component to control a charging operation of the charging component based on the control signal. Both the testing sensor and the charging terminal are configured to be mated with the mating charging terminal. The control circuit performs the testing operation simultaneously with the charging operation.

In another embodiment, a charging health monitoring device for monitoring a health of a charging component for an electric vehicle is provided. The charging health monitoring device includes a testing sensor includes a testing probe held by a charging terminal for the charging component. The testing probe is electrically isolated from the charging terminal. The testing probe includes a sensing interface configured to interface with a mating charging terminal. The charging health monitoring device includes a control circuit for the charging component. The control circuit is operably coupled to the testing sensor to control a testing operation using the testing sensor. The control circuit includes an operational amplifier receiving a voltage signal from the testing probe and receiving a voltage signal from the charging terminal. The operational amplifier provides a test signal. The control circuit includes an electrically isolated switch receiving the test signal. The electrically isolated switch generates a control signal based on the test signal. The control circuit is operably coupled to the charging component to control a charging operation of the charging component based on the control signal. The testing sensor and the charging terminal are configured to be mated with the mating charging terminal to perform the charging operation. The control circuit performs the testing operation simultaneously with the charging operation.

In a further embodiment, a method of monitoring health of a charging terminal of a charging component configured to be mated with a mating charging terminal to charge an electric vehicle during a charging operation is provided. The method provides a charging health monitoring device includes a testing sensor and a control circuit operably coupled to the testing sensor. The testing sensor has a testing probe. The control circuit includes an electrically isolated switch. The method mates the testing sensor and the charging terminal with the mating charging terminal such that the testing sensor engages the mating charging terminal. The method measures a terminal voltage of the charging terminal at the control circuit and measures a sensor voltage of the testing sensor at the control circuit. The method determines resistance of the charging terminal based on the measured terminal voltage and the measured sensor voltage. The control circuit provides a test signal based on the measured resistance to the electrically isolated switch. The method generates a control signal at the electrically isolated switch based on the test signal and controls a charging operation of the charging component based on the control signal.

### BRIEF DESCRIPTION OF THE DRAWINGS

FIG. 1 illustrates a charging health monitoring system in accordance with an exemplary embodiment.

FIG. 2 is a schematic view of the monitoring device in accordance with an exemplary embodiment.

FIG. 3 is a schematic view of the monitoring device in accordance with an exemplary embodiment.

FIG. 4 is a schematic view of the monitoring device in accordance with an exemplary embodiment.

FIG. 5 is a schematic view of the monitoring device in accordance with an exemplary embodiment.

FIG. 6 is a schematic view of the monitoring device in accordance with an exemplary embodiment.

### DETAILED DESCRIPTION OF THE INVENTION

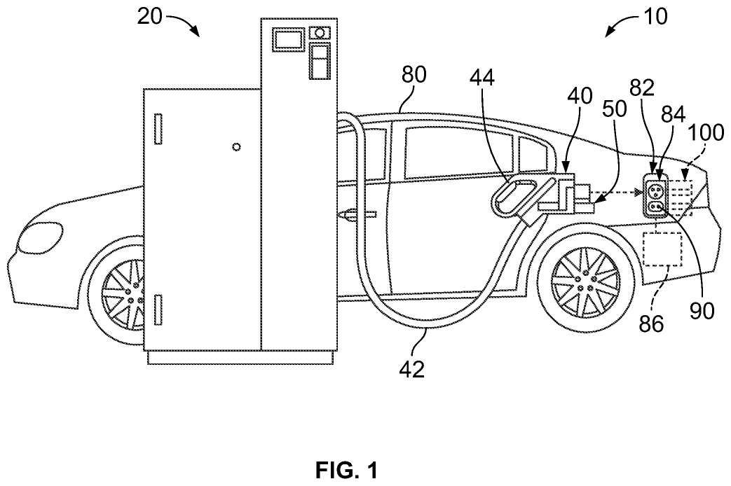

FIG. 1 illustrates a charging health monitoring system 10 in accordance with an exemplary embodiment. The charging health monitoring system 10 includes a charging health monitoring device 100 (which may be referred to hereinafter as a monitoring device 100). The monitoring device 100 is used for monitoring health of charging terminals used for charging an electric vehicle 80. The charging health monitoring system 10 measures charging interface health when the vehicle 80 is connected to a charging station 20. The charging health monitoring system 10 may provide a signal that allows or disallows charging based on the measured health of that particular separable interface. The charging health monitoring system 10 reduces dissatisfaction with low charging rates, the potential for harmful user intervention (jiggling the charging plug to increase charging rate) or damage to the inlet and charging plug due to poor interface health.

The monitoring device 100 may be incorporated into the electric vehicle 80 and/or the charging station 20 for charging the electric vehicle 80 to monitor health of the charging components, such as to control the charging operation. For example, the monitoring device 100 may allow or disallow the charging operation based on the health of the charging terminals. In an exemplary embodiment, the monitoring device 100 measures interface resistance at the interface of the charging terminals to determine a health of the charging components. If the interface resistance is too high, the monitoring device 100 may disallow the charging operation leading the operator to use a different charging station 20 and/or to repair or replace the charging components to improve the charging operation.

The electric vehicle 80 includes a charging inlet 82 having charging terminals 90. In an exemplary embodiment, the charging inlet 82 includes a receptacle configured to receive a charging plug. In various embodiments, the charging inlet 82 is operable as a standard type charging inlet, such as an SAE J1772 inlet. In an exemplary embodiment, the charging terminals 90 are pin terminals. However, other types of charging terminals may be used in alternative embodiments. The charging inlet 82 is mounted to the vehicle 80. The charging inlet 82 is electrically connected to a battery 86 of the electric vehicle 80. The charging terminals 90 are supplied power from the charging station 20 to recharge the battery 86.

The charging station 20 includes a charging plug 40 at an end of a charging cable 42. The charging plug 40 is configured to be mated with the charging inlet 82. The charging station 20 supplies power to the charging plug 40 to charge the electric vehicle 80. The charging plug 40 may be a Level 1 charger, a Level 2 charger or a Level 3 charger. In an exemplary embodiment, the charging plug may be a DC fast charging plug. The charging plug 40 may be any type of electric vehicle charging interface having an arrangement of charging terminals, such as a combined charging system (CCS) having both AC charging terminals and DC charging terminals. The charging plug 40 includes a handle 44 holding charging terminals 50. In an exemplary embodiment, the charging terminals 50 are charging sockets. The charging terminals 50 are configured to be received in the receptacle 84 to mate with the charging terminals 90 of the charging inlet 82.

In various embodiments, the monitoring device 100 is part of the electric vehicle 80. For example, the monitoring device 100 may be part of the charging inlet 82. The monitoring device 100 may be part of the battery system. In other various embodiments, the monitoring device 100 is part of the charging station 20. For example, the monitoring device 100 may be part of the charging plug 40. The monitoring device 100 may control the power supply from the charging station 20 to the charging inlet 82. For example, the monitoring device 100 may shut off the charging operation if the health of the charging components at the charging interface is determined to be unhealthy. For example, if there is high electrical resistance at the charging interface, such as due to damage or deterioration, the charging operation may be disallowed. In an exemplary embodiment, the monitoring device 100 enables individual consumers, fleet owners, charging station maintenance contractors, or other individuals to assess the health of the charging plug 40 and determine if any maintenance and/or replacement of the charging plug 40 or components thereof is required. The monitoring device 100 measures the resistance of the connection in the charging plug 40 to determine the health of the charging terminals 50. In an exemplary embodiment, the monitoring device 100 compares the measured resistance with a known database of connections ranging from good to poor and provides the user with an indication of health of the particular charging terminals 50 to determine if the charging terminals 50 need service or replacement. The monitoring device 100 may provide an output to the user indicative of the health of the charging terminals 50, which may be displayed at the charging station 20 and/or within the electric vehicle 80.

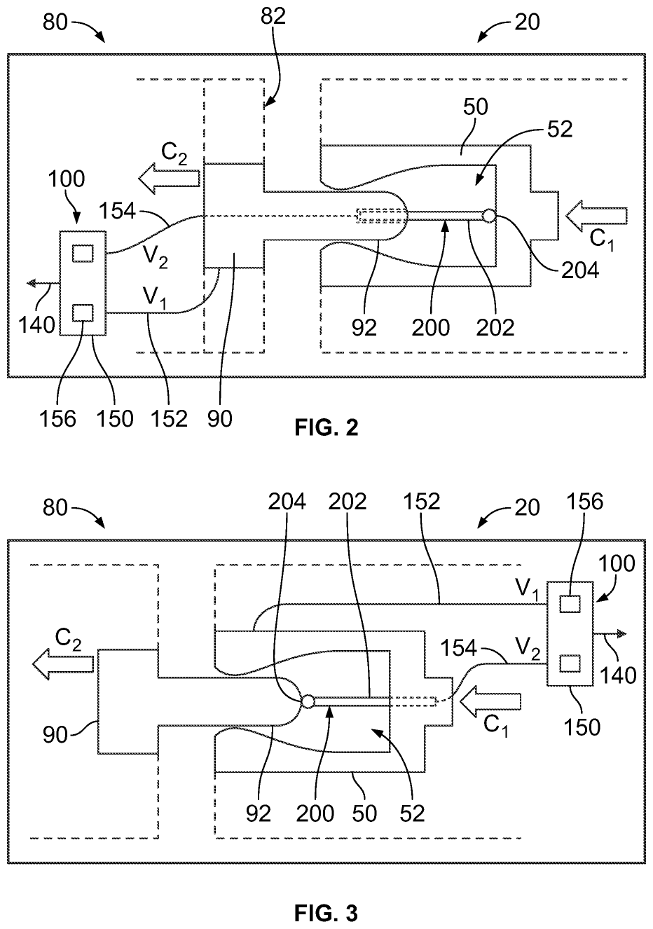

FIG. 2 is a schematic view of the monitoring device 100 in accordance with an exemplary embodiment. In the illustrated embodiment, the monitoring device 100 is part of the charging inlet 82. The monitoring device 100 is coupled to the charging terminal 90. FIG. 2 shows the charging terminal 90 including a pin 92 received in a socket 52 of the charging terminal 50. The monitoring device 100 assesses the health of the charging terminal 50 and/or the charging terminal 90 to determine if charging should or can occur and/or to determine if any maintenance and/or replacement of the charging components is required. The monitoring device 100 measures the resistance of the interface between the charging terminals 50, 90.

The monitoring device 100 includes a control circuit 150 and a testing sensor 200 for monitoring the charging components, such as for monitoring the charging terminal 50 and/or the charging terminal 90. In an exemplary embodiment, the testing sensor 200 includes a testing probe 202. The testing probe 202 is held by the charging terminal 90. For example, the testing probe 202 may be received in an opening or channel in the pin 92 and extends from the pin 92 to interface with the charging terminal 50. The charging terminal 90 has a mating interface along the pin 92 that is configured to interface with the mating charging terminal 50, such as with mating elements along the socket 52. In an exemplary embodiment, the testing probe 202 is electrically isolated from the charging terminal 90, such as using a film, pad, sleeve, coating, air gap, or other dielectric barrier between the testing probe 202 and the charging terminal 90. The testing probe 202 includes a testing interface 204 that engages or interfaces with the charging terminal 50. In an exemplary embodiment, the testing probe 202 is movable relative to the charging terminal 90 to mate with the mating charging terminal 50. For example, the testing probe 202 may be deflectable or compressible to reliably interface with the charging terminal 50. In various embodiments, the testing probe 202 is a pogo-pin. For example, the testing probe 202 is spring loaded to engage the charging terminal 50. In the illustrated embodiment, the testing probe 202 is aligned with the longitudinal axis of the charging terminal 90 (for example, the pin axis). For example, the testing probe 202 is aligned with and deflectable along a mating axis of the charging terminals 50, 90. The testing probe 202 may extend forward from the distal end of the pin of the charging terminal 90. The testing probe 202 is configured to bottom out against a bottom end of the socket 52, such as against an end wall at the bottom end of the socket 52.

The control circuit 150 is operably coupled to the charging component (for example, the charging station 20 and/or the electric vehicle 80) to control the charging operation using the charging terminals 50, 90. The control circuit 150 is operably coupled to the testing sensor 200 to control a testing operation using the testing sensor 200. For example, the control circuit 150 is coupled to the charging terminal 90 by a first wire 152 and the control circuit 150 is coupled to the testing sensor 200 by a second wire 154. The control circuit 150 receives signals form the charging terminal 90 and the testing sensor 200 through the wires 152, 154. For example, the control circuit 150 may measure voltage, current, or receive other signals. In an exemplary embodiment, the control circuit measures a terminal voltage of the charging terminal 90 and a sensor voltage of the testing sensor 200 to determine resistance of the charging terminal 90 and provide a test signal indicative of or based on the resistance. The resistance may be determined as the voltage difference between the measured voltages of the charging terminal 90 and the testing sensor 200 divided by the charging current. In an exemplary embodiment, the control circuit 150 is a resistance sensor (for example, a two wire resistance sensor) configured to determine a resistance measurement for the charging terminal 50. The control circuit 150 uses a two wire interface resistance measurement to control the charging operation.

In an exemplary embodiment, the control circuit 150 measures a terminal voltage of the charging terminal 50 and measures a sensor voltage of the testing sensor 200. The control circuit 150 determines resistance of the charging terminal 50 and the charging terminal 90 based on the measured terminal voltage and the measured sensor voltage divided by the measured charging current. The control circuit 150 includes circuit components 156 for controlling operation of the monitoring device 100. The circuit components 156 may include resistors, capacitors, inductors, transistors, diodes, operational amplifiers, differential amplifiers, integrated circuits, processors, memories, communication components, switches, an electrically isolated switch, a galvanic barrier, an optocoupler, or other types of circuit components. In an exemplary embodiment, the control circuit 150 is configured to provide one or more outputs. For example, the control circuit 150 may generate a control signal 140 to control the charging operation. In various embodiments, the output may be used to shut off or disallow the charging operation to occur. For example, the control circuit 150 controls the charging operation by stopping the charging operation if the measured resistance is above a threshold resistance. The output may be transmitted to the user to provide an indication of the operation health of the charging components, such as by display on a display device.

In an exemplary embodiment, both the testing sensor 200 and the charging terminal 90 are configured to be mated with the mating charging terminal 50 (the socket terminal) when the charging plug 40 is plugged into the charging inlet 82 of the vehicle 80. The control circuit 150 performs the testing operation simultaneously with the charging operation. Optionally, the control circuit 150 may perform the testing operation once when first mated, such as at the start of the charging operation. In other embodiments, the control circuit 150 performs the testing operation continuously during the charging operation. In other embodiments, the control circuit 150 performs the testing operation at intervals, such as by pulsing test signals at regular intervals during the charging operation.

FIG. 3 is a schematic view of the monitoring device 100 in accordance with an exemplary embodiment. In the illustrated embodiment, the monitoring device 100 is part of the charging station 20. The monitoring device 100 is coupled to the charging terminal 50. FIG. 3 shows the charging terminal 90, including the pin 92, received in the socket 52 of the charging terminal 50. The monitoring device 100 assesses the health of the charging terminal 50 and/or the charging terminal 90 to determine if charging should or can occur and/or to determine if any maintenance and/or replacement of the charging components is required. The monitoring device 100 measures the resistance of the interface between the charging terminals 50, 90.

The monitoring device 100 includes the control circuit 150 and the testing sensor 200 for monitoring the charging components, such as for monitoring the charging terminal 50 and/or the charging terminal 90. In the illustrated embodiment, the testing probe 202 is held by the charging terminal 50. For example, the testing probe 202 may be received in an opening or channel formed in the bottom of the socket 52 and extends from the bottom into the socket 52 to interface with the charging terminal 90. In an exemplary embodiment, the testing probe 202 is electrically isolated from the charging terminal 50, such as using a film, pad, sleeve, coating, air gap, or other dielectric barrier between the testing probe 202 and the charging terminal 50. The testing interface 204 of the testing probe 202 is configured to engage or interface with the charging terminal 90. In an exemplary embodiment, the testing probe 202 is deflectable to reliably interface with the charging terminal 90. The testing probe 202 may be a spring loaded pogo-pin. In the illustrated embodiment, the testing probe 202 is aligned with the longitudinal axis of the charging terminal 50 (for example, aligned with the central axis of the socket 52). The testing probe 202 is configured to interface with the distal end of the pin 92 when the pin 92 is plugged into the socket 52.

The control circuit 150 is operably coupled to the charging component (for example, the charging station 20 and/or the electric vehicle 80) to control the charging operation using the charging terminals 50, 90. The control circuit 150 is operably coupled to the testing sensor 200 to control a testing operation using the testing sensor 200. For example, the control circuit 150 is coupled to the charging terminal 50 by the first wire 152 and the control circuit 150 is coupled to the testing sensor 200 by the second wire 154. The control circuit 150 receives signals form the charging terminal 50 and the testing sensor 200 through the wires 152, 154. For example, the control circuit 150 may measure voltage, current, or receive other signals. In an exemplary embodiment, the control circuit 150 is a resistance sensor (for example, a two wire resistance sensor) configured to determine a resistance measurement for the charging components.

In an exemplary embodiment, the control circuit 150 measures a terminal voltage of the charging terminal 50 and measures a sensor voltage of the testing sensor 200. The control circuit 150 determines resistance of the charging terminal 50 and the charging terminal 90 based on the measured terminal voltage and the measured sensor voltage. The control circuit 150 includes the circuit components 156 for controlling operation of the monitoring device 100. The circuit components 156 may include resistors, capacitors, inductors, transistors, diodes, operational amplifiers, differential amplifiers, integrated circuits, processors, memories, communication components, switches, an electrically isolated switch, a galvanic barrier, an optocoupler, or other types of circuit components. In an exemplary embodiment, the control circuit 150 is configured to provide one or more outputs. For example, the control circuit 150 may generate the control signal 140 to control the charging operation. In various embodiments, the output may be used to shut off or disallow the charging operation to occur. The output may be transmitted to the user to provide an indication of the operation health of the charging components, such as by display on a display device.

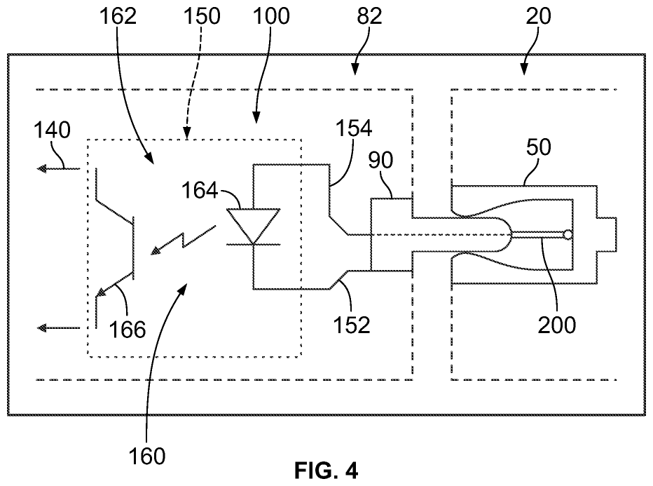

FIG. 4 is a schematic view of the monitoring device 100 in accordance with an exemplary embodiment. In the illustrated embodiment, the monitoring device 100 is part of the charging inlet 82; however, the monitoring device 100 may be part of the charging station 20 in alternative embodiments. The monitoring device 100 is shown coupled to the charging terminal 90. The monitoring device 100 assesses the health of the charging components. For example, the monitoring device 100 measures the resistance of the interface between the charging terminals 50, 90. The monitoring device 100 is used to measure a resistance of the charging terminal 50 using the testing sensor 200. FIG. 4 illustrates a two wire resistance measurement circuit for the monitoring device 100. The testing sensor 200 is used to accurately measure resistance in the charging terminal 50 to monitor the health of the charging terminal 50. The testing sensor 200 differentiates between a good connection and a bad connection, such as by comparing the measured resistance to a threshold resistance value and/or a database of known connections. As such, the monitoring device 100 can be used to determine if the charging terminal 50 needs to be serviced or replaced.

In an exemplary embodiment, the control circuit 150 includes a voltmeter. A pair of voltage-sensing wires are connected to the voltmeter to measure the voltage drop through the charging terminal 50.

In an exemplary embodiment, the control circuit 150 includes an electrically isolated switch 160 generating the control signal 140 based on the test signals from the testing sensor 200. The control signal 140 may be further processed or may be used directly to control operation of the charging system (for example, allow or disallow charging or control the charging rate). The electrically isolated switch 160 forms a galvanic barrier between the charging components (for example, the charging terminals 50, 90), which are at high voltage, and the circuit components or other systems of the vehicle. In an exemplary embodiment, the electrically isolated switch 160 includes an optocoupler 162 forming an optical connection between the charging side and the isolated side of the control circuit 150. The optocoupler 162 includes an emitter 164 and a phototransistor 166. The emitter 164 may be a diode, such as an IR diode. The emitter 164 is coupled to the wires 152, 154 and generates light output based on the signals from the testing sensor 200. The phototransistor 166 receives the optical signals from the emitter 164 and generates a digital output based on the received optical signals. The optocoupler 162 may include other components in alternative embodiments that transfer electrical signals between two isolated circuits by using light. In other alternative embodiment, rather than using an optocoupler, the electrically isolated switch 160 may provide isolated circuits using capacitive components, inductive components, radiative components, acoustic components or mechanically coupled components.

In an exemplary embodiment, the optocoupler 162 is activated when the voltage drop across the separable interface rises to a bandgap potential of the emitter 164. The optocoupler 162 provides the needed galvanic isolation between the charging terminal 90 and the vehicle electrical system. The phototransistor 166 on the isolated side of the optocoupler 162 signals the vehicle to stop the charging operation if poor health is determined. The switching potential of the optocoupler 162 may be limited to the available diode bandgap voltages. In various embodiments, the emitter 164 may be an IR emitter to obtain a low bandgap voltage (for example, 1.8V).

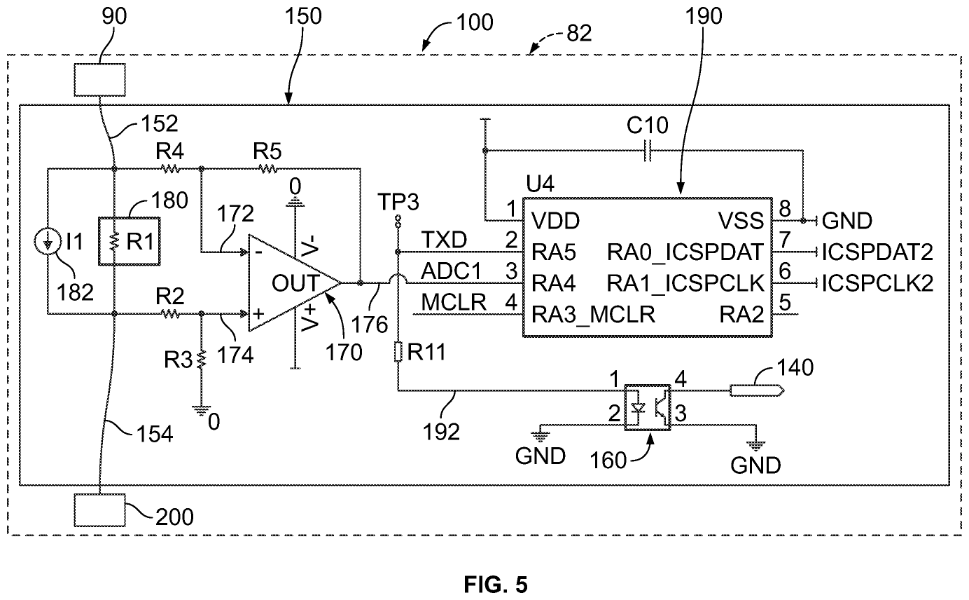

FIG. 5 is a schematic view of the monitoring device 100 in accordance with an exemplary embodiment. In an exemplary embodiment, the monitoring device 100 generates a digital output as the control signal 140 for controlling the charging system. The monitoring device 100 may be part of the charging inlet 82 or the charging plug 40 of the charging station 20. The monitoring device 100 assesses the health of the charging components. For example, the monitoring device 100 measures the resistance of the interface between the charging terminals 50, 90. The monitoring device 100 is used to measure a resistance of the charging terminal 50 using the testing sensor 200 and generates the control signal 140 based on the resistance which is a measure of the health of the charging components.

In an exemplary embodiment, the control circuit 150 includes an operational amplifier (opamp) 170. In an exemplary embodiment, the opamp 170 is a differential amplifier that measures and amplifies voltage drop across the separable interface. The opamp 170 includes a first input 172 from the first wire 152 and a second input 174 from the second wire 154. The opamp 170 generates a test signal 176 as an output. The test signal 176 may be an analog signal. The test signal 176 is based on a contact resistance 180 at the mating interface between the charging terminals 50, 90. A charging current is represented by the current source 182. In an exemplary embodiment, the control circuit 150 includes an analog to digital converter (ADC) 190. The ADC 190 converts the analog test signal 176 to a digital test signal 192. The digital test signal 192 is transmitted to the electrically isolated switch 160. The electrically isolated switch 160 generates the control signal 140. The output of the opamp 170 is sent to the ADC 190, which digitizes the analog value and sends it to the vehicle through the electrically isolated switch 160. The signal sent to the vehicle can be either a simple on-off value that indicates a satisfactory interface, a digital bit stream that corresponds to measured voltage drop, a PWM (Pulse Width Modulated) signal proportional to voltage drop, or another type of signal.

The monitoring device 100 is used to accurately measure resistance in the charging terminal 50 to monitor the health of the charging terminal 50. The monitoring device 100 differentiates between a good connection and a bad connection, such as by comparing the measured resistance to a threshold resistance value and/or a database of known connections. As such, the monitoring device 100 can be used to determine if the charging terminal 50 needs to be serviced or replaced.

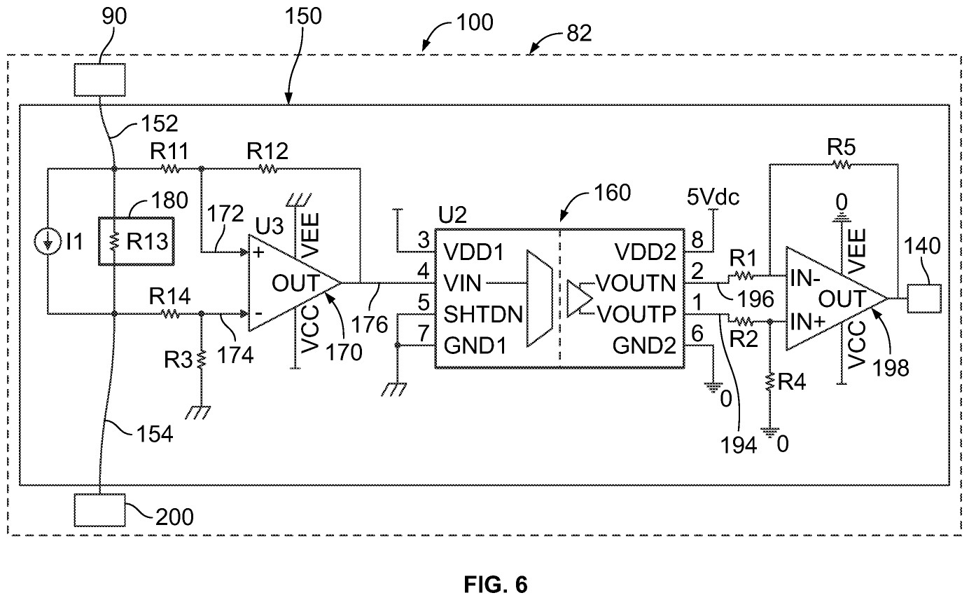

FIG. 6 is a schematic view of the monitoring device 100 in accordance with an exemplary embodiment. In an exemplary embodiment, the monitoring device 100 generates an analog output as the control signal 140 for controlling the charging system. The monitoring device 100 may be part of the charging inlet 82 or the charging plug 40 of the charging station 20. The monitoring device 100 assesses the health of the charging components. For example, the monitoring device 100 measures the resistance of the interface between the charging terminals 50, 90. The monitoring device 100 is used to measure a resistance of the charging terminal 50 using the testing sensor 200 and generates the control signal 140 based on the resistance which is a measure of the health of the charging components.

In an exemplary embodiment, the control circuit 150 includes the opamp 170. The opamp 170 includes the first input 172 from the first wire 152 and the second input 174 from the second wire 154. The opamp 170 generates the test signal 176 as an output. The test signal 176 may be an analog signal. The test signal 176 is based on the contact resistance 180 at the mating interface between the charging terminals 50, 90. The test signal 176 is transmitted to the electrically isolated component 160. In an exemplary embodiment, the electrically isolated component 160 is an op-amp with a built-in galvanic barrier. The electrically isolated component 160 generates a first output 194 and a second output 196. The electrically isolated component 160 conveys the test signal 176 to the outputs 194, 196 while blocking the high voltage present at the input side. The first and second outputs 194, 196 are transmitted to an isolated opamp 198 on the isolated side of the control circuit 150. The isolated opamp 198 generates the control signal 140. In the illustrated embodiment, the control signal 140 is an analog control signal. The electrically isolated component 160 moves the galvanically isolated analog signal from the testing opamp 170 at left to the isolated opamp 198 at right. The isolated opamp 198 converts the differential signal to an analog representation of the voltage differential (for example, voltage at charging terminal 50 minus voltage at testing sensor 200) as the output or control signal 140.

The monitoring device 100 is used to accurately measure resistance in the charging terminal 50 to monitor the health of the charging terminal 50. The monitoring device 100 differentiates between a good connection and a bad connection, such as by comparing the measured resistance to a threshold resistance value and/or a database of known connections. As such, the monitoring device 100 can be used to determine if the charging terminal 50 needs to be serviced or replaced.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A charging health monitoring device for monitoring health of a charging component for an electric vehicle, the charging health monitoring device comprising:
a charging terminal configured to be mated with a mating charging terminal to perform a charging operation for charging the electric vehicle;
a testing sensor held by the charging terminal, the testing sensor including a testing probe, the testing probe being electrically isolated from the charging terminal, the testing probe including a sensing interface configured to interface with a mating charging terminal;
a control circuit for the charging component, the control circuit being operably coupled to the charging terminal to control the charging operation using the charging terminal, the control circuit being operably coupled to the testing sensor to control a testing operation using the testing sensor, the control circuit measuring a terminal voltage of the charging terminal, the control circuit measuring a sensor voltage of the testing sensor, the control circuit determining resistance of the charging terminal and the mating charging terminal based on the measured terminal voltage and the measured sensor voltage, the control circuit providing a test signal based on the measured resistance, the control circuit including an electrically isolated switch receiving the test signal, the electrically isolated switch generating a control signal based on the test signal, the control circuit being operably coupled to the charging component to control a charging operation of the charging component based on the control signal;
wherein both the testing sensor and the charging terminal are configured to be mated with the mating charging terminal, the control circuit performing the testing operation simultaneously with the charging operation.

2. The charging station health monitoring device of claim 1, wherein the control circuit uses a two wire interface resistance measurement to control the charging operation.

3. The charging station health monitoring device of claim 1, wherein the testing probe is movable relative to the charging terminal to mate with the mating charging terminal.

4. The charging station health monitoring device of claim 1, wherein the testing operation occurs during the charging operation.

5. The charging station health monitoring device of claim 1, wherein the control circuit controls the charging operation by stopping the charging operation if the measured resistance is above a threshold resistance.

6. The charging station health monitoring device of claim 1, wherein the charging terminal is a pin terminal and the mating charging terminal is a socket terminal, the testing probe is received in the socket terminal with the pin terminal to mate with the socket terminal.

7. The charging station health monitoring device of claim 1, wherein the charging terminal is a socket terminal and the mating charging terminal is a pin terminal, the testing probe being located in a socket of the socket terminal to mate with the pin terminal when the pin terminal is plugged into the socket.

8. The charging station health monitoring device of claim 1, wherein the charging terminal has a mating interface, the control circuit measuring the resistance of the mating interface.

9. The charging station health monitoring device of claim 1, wherein the control circuit measures a charging current of the charging terminal, the resistance determined as the voltage difference divided by the charging current.

10. The charging station health monitoring device of claim 1, wherein the electrically isolated switch is an optocoupler.

11. The charging station health monitoring device of claim 1, wherein the control circuit includes an operation amplifier receiving the sensor voltage from the testing sensor and receiving the terminal voltage from the charging terminal, the operational amplifier providing the test signal as an output.

12. The charging station health monitoring device of claim 1, wherein the control circuit includes a differential amplifier receiving the sensor voltage and the terminal voltage.

13. The charging station health monitoring device of claim 1, wherein the control signal generated by the control circuit is a pulse width modulated signal.

14. The charging station health monitoring device of claim 1, wherein the control signal generated by the control circuit is an on/off value to control the charging operation.

15. The charging station health monitoring device of claim 1, wherein the control circuit includes an analog to digital converter, the control signal generated by the control circuit is a digital signal.

16. The charging station health monitoring device of claim 1, wherein the control signal generated by the control circuit is an analog signal.

17. A charging health monitoring device for monitoring a health of a charging component for an electric vehicle, the charging health monitoring device comprising:
a testing sensor including a testing probe held by a charging terminal for the charging component, the testing probe being electrically isolated from the charging terminal, the testing probe including a sensing interface configured to interface with a mating charging terminal;
a control circuit for the charging component, the control circuit being operably coupled to the testing sensor to control a testing operation using the testing sensor, the control circuit including an operation amplifier receiving a voltage signal from the testing probe and receiving a voltage signal from the charging terminal, the operational amplifier providing a test signal, the control circuit including an electrically isolated switch receiving the test signal, the electrically isolated switch generating a control signal based on the test signal, the control circuit being operably coupled to the charging component to control a charging operation of the charging component based on the control signal;
wherein the testing sensor and the charging terminal are configured to be mated with the mating charging terminal to perform the charging operation, the control circuit performing the testing operation simultaneously with the charging operation.

18. The charging station health monitoring device of claim 17, wherein the control circuit uses a two wire interface resistance measurement to control the charging operation.

19. The charging station health monitoring device of claim 17, wherein the electrically isolated switch is an optocoupler.

20. A method of monitoring health of a charging terminal of a charging component configured to be mated with a mating charging terminal to charge an electric vehicle during a charging operation, the method comprising:
providing a charging health monitoring device including a testing sensor and a control circuit operably coupled to the testing sensor, the testing sensor having a testing probe, the control circuit including an electrically isolated switch;
mating the testing sensor and the charging terminal with the mating charging terminal such that the testing sensor engages the mating charging terminal;
measuring a terminal voltage of the charging terminal at the control circuit;
measuring a sensor voltage of the testing sensor at the control circuit;
determining resistance of the charging terminal based on the measured terminal voltage and the measured sensor voltage, the control circuit providing a test signal based on the measured resistance to the electrically isolated switch;
generating a control signal at the electrically isolated switch based on the test signal; and
controlling a charging operation of the charging component based on the control signal.
